(19) United States
(12) Patent Application Publication
(10) Pub. No.: US 2016/0192617 A1
(43) Pub. Date: Jul. 7, 2016

(54) Vapor Proof Dual Cover System for Pet Beds with Pressure Relief Zones

(71) Applicant: Michael E. Murphy, LaCrosse, WI (US)

(72) Inventor: Michael E. Murphy, LaCrosse, WI (US)

(21) Appl. No.: 14/588,619

(22) Filed: Jan. 2, 2015

(51) Int. Cl. A01K 1/035; A47G 9/02

(52) U.S. Cl. CPC A01K 1/0353; A47G 9/0238

(57) ABSTRACT

A Dual Cover System for pet bed mattresses comprised of a water proof and vapor proof inner covering and a machine washable, decorative outer covering. Both inner and outer covers have corresponding Pressure Relieving Zones that allow the animal's unique shape and weight to descend into the cushioning layers without the resistance otherwise created by the taught fabric of a form fitted cover.

### CROSS-REFERENCE TO RELATED APPLICATIONS

### (Not Applicable)

### STATEMENT REGARDING FEDERALLY SPONSORED RESEARCH OR DEVELOPMENT

### (Not Applicable)

### REFERENCE TO SEQUENCE LISTING, A TABLE, OR A COMPUTER PROGRAM LISTING COMPACT DISC APPENDIX

### (Not Applicable)

### BACKGROUND OF THE INVENTION

### Technical Field

This invention relates to the coverings used on and around pet-beds. Whether for use by sporting dogs, which are often wet and soiled, or by sick or elderly dogs, which often have issues related to drainage, incontinence and interface pressure.

### BRIEF SUMMARY OF THE INVENTION

Pet-beds are commonly used by pet owners to provide their animal with a specific place to sleep and rest. Beds are often designed or purchased with little more for consideration than size or fabric color. Some provide the option of a moisture repellent liner to help protect the bed's core material from fluid contamination. However, moisture repellent liners fail to stop moisture vapor transmission and core contamination, which is inevitable under a damp or incontinent pet.

Some beds utilize core materials such as convoluted or memory foams with the intent of comforting or protecting ailing, aging or arthritic pets. However, the therapeutic benefits of these core materials are not realized when the bed's coverings fail to allow the pet's unique shape, weight and movements to immerse freely into the cushion.

Whereas the core construction of some pet beds may be intended to reduce interface pressure for sensitive, ailing or elderly animals, the desired therapeutic benefits are hindered or negated completely if the animal's unique shape and weight are prevented from descending into the support medium, (foam, fiber, visco), by the resistance of the bed's taught mattress cover. This invention overcomes the resistance by creating an area of loose, billowy fabric as a part of both the inner and outer cover components. The invention solves the emersion resistance problems caused by a taught fabric, by creating vertically darted fabric panels to transform an abundance of fabric into dimensionally correct panels and then affixing each panel in coplanar fashion to the form-fitted portions of the covers. These vertically darted panels, one made with the Vapor proof nylon, is affixed to the form-fitted portions of the also Vapor proof inner cover and the second vertically darted panel is made with the washable decorative fabric and affixed in the same way, to the form fitted portion of the invention's decorative outer cover.

Each billowy panel of fabric is positioned and affixed to the form fitted portions of the inner cover and outer cover where they will be positioned in tandem, over the mattresse's cushioning material, providing the less resistant area atop the mattresses' cushioning material where the animal's body is positioned when at rest.

To address the hygienic issues caused by a wet sporting dog or an incontinent pet, which could ruin a pet bed, some offer a waterproof cover or waterproof liner. Some Prior Art specify the use of a waterproof, yet breathable fabric cover or liner. However, waterproof alone is not an effective barrier against contamination when the bed is subjected to the real-world effects of body weight, body heat, moisture-vapor and moisture-vapor transmission into the bed's support materials. A waterproof fabric, which claims to be breathable, denotes that the fabric allows vapor pass-through. Any breathability or inadequate MVT resistance will allow moisture vapors to be drawn into the pet bed's core materials where they accumulate, again becoming a fluid, resulting in the cushioning material's contamination.

This invention surrounds any core components with a fluid and vapor proof butyl backed nylon cover, with an MVT rating of less than 1.0 grams/hr/m2 (moisture vapor transmission) as defined by ASTM: E96-80 resistance. This moisture resistance level ensures that evaporating moisture (water, blood, urine, etc.) will not pass through the covering and then accumulate within the core materials resulting in contamination, mold and odors.

One embodiment of this invention is that the butyl backed, vapor-proof nylon fabric is sewn with the nylon surface facing outward to utilize its low-shear properties. This invention uses a 70 to 100 denier nylon as it provides the needed slick, low shear properties while providing the therapeutic pliability nylons of a higher denier do not. This is important as this low-shear allows the system's decorative, outer cover to move easily across the inner cover, enhancing the emersion effect of the animal's shape and movements. The slick, low-shear nature of this nylon also serves to facilitate the ease of assembly, removal, cleaning and re-insertion of the covered inner cushions into the form-fitted outer cloth cover. The nylon's butyl backing is unique and most important to the invention's function and long-term utility.

Other inventions claim the use of plastic, urethane or vinyl coated fabric to provide water repellency. These agents fail to provide a vapor-proof barrier and have plasticizers, which are gradually absorbed by the bed's cushioning materials, leaving the fabric even less resistant to moisture pass-through. The butyl coating provides an effective liquid and vapor barrier and have no plasticizer additives, therefore, no plasticizer migration from the fabric to the cushioning materials.

The invention's unique use of a dual cover system, with its vapor-proof inner cover serve to prevent core contamination, whether simply from a wet sporting dog, pet incontinence or from a pet at end-of-life suffering with blood discharge. This invention incorporates a butyl-backed, low-shear nylon fabric to produce the inner cover, which provides an MVT, (moisture vapor transmission,) as defined by ASTM: E96-80 resistance, rating of less than 1 grams/hr/m2. A pet bed that does not prevent MVT allows vapor molecules to be drawn through the cover fabrics, into the compressed foam core materials, where they accumulate, resulting in a wet, contaminated and odorous pet bed.

What is needed is a pet bed cover that provides for a decorative appearance suitable for placement in an owner's home and the moisture and soiling barrier protection that prevents odor causing contamination. A cover that fits the form of the bed's core dimensions, yet provides for the unrestricted immersion to maximize pressure redistribution, specifically where the animal rests.

### PRIOR ART REFERENCES CITED

### US Patent Documents

| Patent Number | Inventor | Date of Patent |
|---|---|---|
| 5,144,911 | Moore et al. | September - 1992 |
| 8,464,657 | King | June - 2013 |
| 7,185,604 | Holte | March - 2007 |
| 8,671,887 | Baker et al. | March - 2014 |
| 5,000,116 | Fife | March - 1991 |
| 7,614,362 | Dunn - Hatherill | November - 2009 |
| 3,763,907 | Hockley | October - 1973 |
| 5,537,952 | Devlin | July - 1996 |

### DESCRIPTION OF PRIOR ART

It is known that there are pet beds having coverings which are breathable, water repellent or water-proof. Some claim the use of protective liners placed between the beds core cushioning material an outer cover. Prior art shows a number of pet beds claiming these properties, as they are beneficial in that animals using the pet beds are often covered with soils, moisture or can be incontinent. However, none make claim too or are comprised of a dual cover system with an inner cover being water/vapor-proof nylon fabric and removable outer cover comprised of a decorative and machine washable cotton or polyester fabric.

None make claim of an inner cover made with low drag coefficient nylon, of any denier, to facilitate either the easy placement of the systems outer cover and/or to create the slick interface to allow for the unrestricted movement of the outer cover across the inner cover to enhance the pets shape, weight and movements into the beds cushioning materials.

None make claim of a dual cover system with matching parallel planes of billowy fabric, specifically positioned where the pet rests.

Prior Art, as in Holte U.S. Pat. No. 7,185,604, describe a flexible waterproof liner to protect against liquids of all nature, but also describe the covering as breathable. This and other patents may also speak of their breathable fabrics, water repellant or waterproof fabrics, but do not sight vapor-proof barriers as a feature.

U.S. Pat. No. 5,144,911 granted to Moore provides for a water-repellent plastic liner around poly-urethane foam and a detachable fleece pad which is affixed with mechanical snaps for pad detachment and washing, when soiled.

U.S. Pat. No. 8,671,887 granted to Baker provides for a pet bed with a plurality of independent geometric shaped cushioning cells for pressure reduction. This invention's cover claims the use of a liquid absorbing, not resistant materials within its' cover.

U.S. Pat. No. 8,464,657 granted to King provides for a 4-layered cover which is designed to absorb and hold moisture, urine and soils within its 2^{nd} layer. It is not form fitted to the cushion and uses elastic straps to flex and retract around cushions of varying shapes.

U.S. Pat. No. 5,000,116 granted to Fife provides for a self-covering pet bed which allows for the pet to climb into the cover, much like a sleeping bag.

U.S. Pat. No. 7,614,362 granted to Dunn-Hatherill provides for a pet bed assembly using cushioning materials listed to be polyurethane foam, polyester fiber-fill and polymeric micro beads, all contained in separate compartments. The cover for this pet bed uses a cloth blanket to absorb moisture and soiling. This cloth blanket is affixed via a zipper assembly, to a water resistant cover. The inventor indicates that extending the moisture resistance to waterproof would be preferable, as the invention provides for an electric heating pad to be positioned between the water resistant fabric and the cushioning materials. This cover description for this invention makes no mention of Moisture Vapor or the prevention of MVT (moisture vapor transmission). No accommodation is made or mentioned to allow for a loose fitting fabric area to prevent the fabric from creating a taught membrane, which would prevent the animals' immersion into the cushioning materials.

U.S. Pat. No. 3,763,907 granted to Hockley provides for a covering to absorb fluid and soils using an absorbent material formed into a storage bag. Stitched to the interior perimeter of the bag is a fluid resistant material for the purpose of creating a barrier against the moisture or fluids from reaching the support material of a human or animal bed.

U.S. Pat. No. 5,537,952 granted to Devlin provides for a waterproof protective sheet described as a layer of high density foam, to drape atop a human bed, pet bed, pillows, etc.

### BRIEF DESCRIPTION OF THE SEVERAL VIEWS OF THE DRAWING

FIG. 1 shows the inner cover of the system, which is constructed with the water and vapor proof, butyl backed nylon

FIG. 2 shows the cover in profile and illustrates the Comfort Zone created by the oversized, billowy fabric panel, which allows the downward pressure generated by a pet's shape and weight to immerse into the bed without the resistance which would otherwise be created by taught, form-fitted coverings.

FIG. 3 shows the outer cover of the system, which is constructed with a soft, decorative cloth fabric and can be easily removed, washed and reapplied.

### DETAILED DESCRIPTION OF THE SEVERAL VIEWS OF THE DRAWING

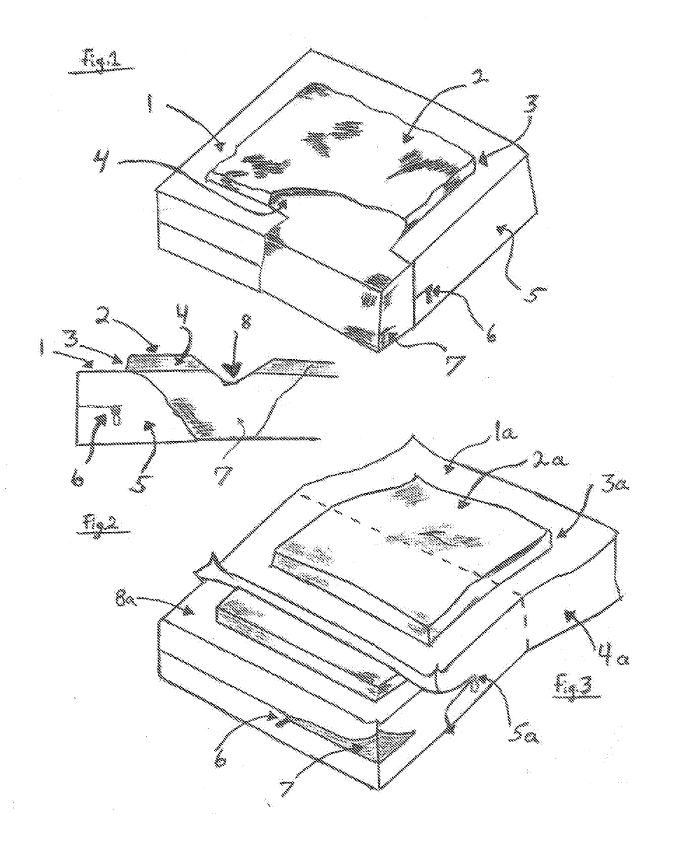

FIG. 1: Illustrates the Waterproof-Vapor proof inner cover portion of the cover's system encasing a foam core cushion.

FIG. 1-1 points to the form fitted portion of the top, resting surface of the inner cover. This panel is of a dimensional size, which creates a perimeter of fabric, which fits atop the dimensional size of the core of the pet bed cushion. An area from the center of surface 1 is removed to create an opening exposing the surface of the core material.

FIG. 1-2 points to the loosely fitted, billowy panel of the same butyl backed water and vapor proof, 70 to 100 denier nylon fabric, which makes up the entire inner cover portion of the system. This panel is of greater dimensions than the opening created in panel 1. The greater dimensions of panel 2 are gathered together, as illustrated by 3, at each of the 4 corners to produce vertical darts, reducing the perimeter dimensions to the point where panel 2 can be affixed by sewing within the opening panel 1, thus creating the desired billowy portion of the covers top surface.

FIG. 1-3 points to the darted corners, which are fabricated by gathering the excess fabric of the oversized panel at the 4 corners of the 2 panel. These vertical darts can be of various heights, dictated by the size of the oversized panel 2 and the billowiness desired. For the purposes of this invention the darts gather enough excess fabric and are high enough to permit the pet's unique shape, weight and movements to press down against panel 2 and into the beds cushion illustrated by 7 without meeting the resistance of a taught fabric.

FIG. 1-4 points to the open space and voluminous chamber created over the exposed core material 7 after affixing panel 2 to panel 1.

FIG. 1-5 points to the Waterproof-Vapor proof butyl back fabric inner cover, which surrounds the pet bed's core materials.

FIG. 1-6 points to the zipper assembly, which opens to allow for the insertion of the pet bed's core material.

FIG. 1-7 points to the pet bed's core material.

FIG. 2: provides a profile cross section of the Waterproof-Vapor proof inner cover.

FIG. 2-1 points to the form fitted portion of the top, resting surface of the inner cover. This panel is of a dimensional size, which creates a perimeter of fabric, which fits atop the dimensional size of the core of the pet bed cushion. An area from the center of surface 1 is removed to create an opening exposing the surface of the core material.

FIG. 2-2 points to the loosely fitted, billowy panel of the same waterproof-vapor proof fabric, which makes up the entire inner cover portion of the system. This panel is of greater dimensions than the opening created in panel 1. The greater dimensions of panel 2 are gathered together, as illustrated by 3 at each of the 4 corners to produce vertical darts, reducing the perimeter dimensions to the point where panel 2 can be affixed by sewing within the opening panel 1, thus creating the desired billowy portion of the cover's top surface.

FIG. 2-3 points to the darted corners, which are fabricated by gathering the excess fabric of the oversized panel at the 4 corners of the 2 panel. These vertical darts can be of various heights, dictated by the size of the oversized panel 2 and the billowiness desired. For the purposes of this invention the darts gather enough excess fabric and are high enough to permit the pet's unique shape, weight and movements to press down against panel 2 and into the bed's cushion, illustrated by 7, without meeting the resistance of a taught fabric.

FIG. 2-4 points to the open space and voluminous chamber created over the exposed core material 7 after affixing panel 2 to panel 1.

FIG. 2-5 points to the Waterproof-Vapor proof butyl back fabric inner cover, which surrounds the pet bed's core materials.

FIG. 2-6 points to the zipper assembly, which opens to allow for the insertion of the pet bed's core material.

FIG. 2-7 points to the pet bed's core material.

FIG. 2-8 illustrates the downward pressure of the pet stepping or laying on the pet bed. The oversized, billowy fabric of panel 2 easily follows the downward pressure of the pet thru the unoccupied space 4 into the bed's cushioning material 7 without any resistance of taught covers.

FIG. 3: illustrates the assembly comprised of the system of the pet bed core within the Waterproof-Vapor proof inner cover within the machine washable decorative fabric outer cover.

FIG. 3-1a points to the form fitted portion of the top, resting surface of the inner cover. This panel is of a dimensional size, which creates a perimeter of fabric, which fits atop the dimensional size of the core of the pet bed cushion and the underlying inner cover. An area from the center of surface 1 is removed to create an opening, which is closed with the billowy fabric panel 2a. When assembled the billowy decorative fabric panel 2a is position directly above the billowy water and vapor proof fabric of the panel of the inner cover illustrated in FIG. 1-1.

FIG. 3-2a points to a soft washable fabric panel which, like the systems inner cover, has been fabricated with vertical darts to create the billowy area to facilitate the unrestricted immersion thru the inner cover and into the bed's core materials. This billowy panel of 2a is affixed to panel 1a after gathering the fabric into vertical darts 3a at each of the four corners.

FIG. 3-3a points to the vertical darts in the washable fabric outer portion of the dual cover's system.

FIG. 3-4a points to the machine washable fabric outer cover, which is a replica of the inner cover, except for the fabrics used. This outer cover is made with a decorative machine washable fabric, while the inner cover is made with shear force reducing, butyl backed nylon, which insures the core is never soiled by moisture or moisture vapors.

FIG. 3-5a points to the zipper assembly, which opens to allow for the insertion of the pet bed's core material when covered by the water and vapor proof inner cover.

FIG. 3-6 points to the zipper assembly, which opens to allow for the insertion of the pet bed's core material.

FIG. 3-7 points to the pet bed's core material.

FIG. 3-8a points to the water and vapor proof inner cover fitted, around the pet bed's core material.

### DETAILED DESCRIPTION OF THE INVENTION

Inner Cover Encasement, being water and vapor proof, of a low-shear nylon with an oversized billowy Comfort Zone: A Cover Assembly made with a shear-force reducing, butyl backed nylon fabric. The use of this butyl-backed nylon is essential as it not only prevents the flow of fluids from contaminating the pet bed's cushioning support materials, its prevents any fluids evaporating vapors from passing through into the core where the vapor accumulates and reconstitutes back into a contaminating liquid. The shear-force reducing properties of the inner cover's 70 to 100 denier nylon provide the slick, low drag coefficient to allow the interface of the inventions outer cloth cover to move easily around, across and into the nylon inner cover and ultimately the cushioning material as well. Nylons with a higher denier loose the needed softness and pliability

The slick, low drag coefficient interface is also important to the invention's utility as it permits the easy assembly of the system's covered components when new and when re-assembling the system after laundering the cloth outer cover.

The bottom panel, the side panels and outer perimeter of the top panel of fabric are of the dimensions that, when sewn together, form a snug, form-fitted covering around the majority of the cushion's core material. Affixed to the inside perimeter of the form fitted portion of the top panel is an oversized billowy panel of the same type of nylon fabric.

This oversized panel is positioned atop the majority of resting surface of the pet bed. The loose, billowy effect created by the oversized fabric panel, facilitates the immersion of each pet's unique shape, weight and movements into the cushioning materials of the bed, unrestricted by an otherwise form fitted cover. The oversized dimensions of this panel are reduced to fit within, and be sewn to, the open area of the form-fitted portion the top panel of fabric. The billowy portion of the top surface of the cover is created with a panel of fabric whose dimensions are greater than that of the space to be covered. Each corner of the oversized panel has notches cut away. The remaining fabric along the notch-points is then gathered together into darts and sewn together to reduce the perimeter dimension which can then allow for an oversized, billowy panel to be sewn to the perimeter of the form fitted portion of the top surface panel of the pet bed's cover.

This butyl-backed nylon cover encasement has a zipper assembly sewn on three sides of the cushion's cover to allow for the opening and closing of the cover. The opening of the inner cover encasement allows for the placement and/or removal of the pet bed's cushioning/supportive core.

Outer Cover Encasement, being of a decorative, soft-to-the-touch, non-waterproof cloth with an oversized billowy Comfort Zone: a replication of the inner cover assembly with the only difference being the outer cover is made with decor pleasing upholstery fabrics which are not vapor nor waterproof. The outer cover of the system mirrors the inner cover in its components and construction. The difference between the inner cover and the outer cover is in the fabric used to produce each. The unique dual cover system provides an assembly which provides the pet owner with pet bed having a decorative and machine-washable outer cover and a corresponding inner cover which is impervious to any damage from moisture and soiling. Both the Inner and Outer covers of the system have comfort zones whereas there are corresponding panels which are darted and sewn to provide a loose, billowy area which conforms, unrestricted to a pet shape, weight and movements.

The use of this butyl-backed nylon is essential as it not only prevents the flow of fluids from contaminating the pet bed's cushioning/supportive materials, it prevents a fluid's evaporating vapors from passing thru into the core where the vapors then accumulate and reconstitute back into a contaminating liquid.

The shear-force reducing properties of the inner cover's nylon provide the slick, low drag coefficient to allow the interface of the invention's outer cloth cover to move easily around, across and into the nylon inner cover and ultimately the cushioning material as well. This slippery interface allowing the pet's shape, weight and movements to immerse easily into the bed's core materials, providing optimal pressure absorption and therapeutic benefits.

The slick, low drag coefficient interface is also important to the invention's utility as it permits the easy assembly of the system. The decorative cloth outer cover slides easily onto and around the inner cover's low drag coefficient nylon. This is most helpful when assembling after the original purchase and again when re-assembling the system after the removal and laundering of the systems outer cover.

New and unique embodiments of this invention provide a cover for the foam cushioning components of a pet bed that is waterproof and Vapor proof to prevent the transference of outside moisture and soiling contaminants during the natural evaporation process. This is uniquely functional as moisture & soiling will migrate through a moisture resistant, and even a waterproof cover, when subjected to the real life conditions caused by body-heat, the pressure of body-weight and the internal vacuum created within the bed's compressed foam core.

The use of fabrics chosen specifically for an MVT resistance rating which is less than 1 grams/hr/m2, is both unique and beneficial in the inventions function and utility. Whereas, moisture resistant and even waterproof fabrics are known to be used in pet cushions and mattresses, they fail to effectively stop moisture pass-through, also known as, (MVT—Moisture Vapor Transmission), and core contamination which occurs if a moist environment exists for an hour or more. Under real-life conditions, with an animal's weight pressing against the fabric and the vacuum forces generated when the foams used to provide cushioning are compressed under the pets' weight and movements, moisture and soiling are pulled into the compressed foams as a liquid and become a gas thru evaporation. Without this embodiment, water, urine or other moistures and soils are drawn into the compressed cells of a foam core as they vaporize.

While there are pet beds that claim to provide therapeutic benefits for the animal, most are either a layer of convoluted-eggcrate foam that give the appearance of a healthcare product, or incorporate a layer of visco-elastic memory foam, capitalizing on the marketing of these foams as pressure reducing.

Whereas the core construction of some pet beds may be intended to reduce interface pressure for sensitive, ailing or elderly animals, the desired therapeutic benefits are hindered or negated completely if the animal's unique shape and weight are prevented from descending freely into the support medium,(foam, fiber, visco), by the resistance of the bed's taught, form fitted mattress covering.

The unrestricted immersion allowed by this invention reduces the interface pressure between the pet and the pet bed, maximizing the overall pressure redistribution, promoting uniform support and therapeutic benefits. This is vitally important for the care and comfort of sick, elderly and arthritic pets.

What is claimed to be new, unique and provides a utility and is desired to be protected by Letters of Patent:

1. A dual cover System for pet beds, with an inner nylon cover which is waterproof and vapor proof, by way of a butyl rubber coating that unlike polyurethane or vinyl water proofing agents, will not suffer plasticizer migration and barrier degradation.

2. A dual cover system for pet beds, having a water and vapor proof inner cover, fabricated with a butyl coated, low-shear 70 to 100 denier nylon fabric, capable of resisting moisture vapor transmission (MVT) to levels equal to or less than 1.0 gms/hr/m2 as set forth by ASTM E-96BW testing and a like constructed machine washable, cotton or polyester cloth, outer cover.

3. A dual cover system for pet beds having an inner cover which is water and vapor proof with MVT ratings of less than 1.0 gms-hr-m2 and washable cotton or polyester outer cover having corresponding Pressure Relieving Zones of billowy, non-form fitted, vertically darted fabric panels sewn to the form fitted portions of both inner and outer covers, so that when assembled, outer cover over inner cover, as intended around the beds cushioning core materials, both inner and outer cover's Pressure Relieving Zone panels form parallel planes atop the resting area of beds cushioning core material to allow for the pets unrestricted immersion into the cushioning materials, maximizing comfort and therapeutic support.
